(19) United States
(12) Patent Application Publication
(10) Pub. No.: US 2016/0200899 A1
(43) Pub. Date: Jul. 14, 2016

(54) TIRE WITH TREAD INTENDED FOR BOTH ON AND OFF-THE-ROAD SERVICE

(71) Applicant: The Goodyear Tire & Rubber Company, Akron, OH (US)

(72) Inventors: Leandro Forciniti, Canton, OH (US); Roberto Cerrato Meza, North Canton, OH (US); Warren James Busch, North Canton, OH (US)

(21) Appl. No.: 14/595,425

(22) Filed: Jan. 13, 2015

(51) Int. Cl. C08L 7/00; B60C 1/00

(52) U.S. Cl. CPC C08L 7/00; B60C 1/0016; C08L 2205/025; C08L 2205/03

(57) ABSTRACT

This invention relates to heavy duty pneumatic rubber tires with treads intended for mixed service use on diverse surfaces and to rubber compositions for such tire tread.

### FIELD OF THE INVENTION

This invention relates to heavy duty pneumatic rubber tires with treads intended for mixed service use on diverse surfaces and to rubber compositions for such tire tread.

### BACKGROUND OF THE INVENTION

Pneumatic tires are sometimes intended for heavy duty use such as example for hauling and for traveling over uneven ground when carrying heavy loads which might be referred to as being off-the-road service. Exemplary of such tires are medium truck tires such as, for example, dump trucks, waste haul trucks as well as some bus vehicles.

Pneumatic tires are often intended for use on dedicated road surfaces which might be referred to as being on-the-road service.

However, sometimes such pneumatic tires are also intended for mixed service use to be driven on diverse surfaces including a combination of both roadways and also off-the-road conditions which present more severe use conditions for the tires.

A combination of such intended diverse mixed service use conditions presents significant challenges for rubber compositions for treads of such tires. A balanced combination of lower internal heat generation while maintaining or improving cut growth resistance as well as abrasion resistance properties for the tread rubber is sometimes difficult to obtain. Here, a methodology of achieving such result is to be evaluated, particularly for a rubber composition for a tire tread intended for mixed diverse service.

For heavy duty tire tread work, the principal (primary) elastomer used for the tread rubber composition is often natural rubber (natural cis 1,4-polyisoprene rubber), particularly to promote tear resistance (resistance to cut growth initiation) for the tire tread. The tread rubber may contain a minor amount of cis 1,4-polybutadiene rubber to promote abrasion resistance and thereby resistance to tread wear to promote a greater vehicular driving distance relative to depth of tread worn away.

Such natural rubber-rich treads are in contrast to passenger tire treads for lighter intended duty which are expected to be driven over dedicated roadways while experiencing lower workloads and which may typically be comprised primarily of styrene/butadiene rubber with a minor amount of cis 1,4-polybutadiene rubber and which may also contain a minimal amount of natural rubber, if any.

For example, rubber compositions for natural rubber-based treads of such heavy duty tires for such mixed service may be desired which promote a relatively low hysteresis property for the tread rubber which thereby can promote reduced internal heat buildup in the tread during tire service with a corresponding beneficial increased heat durability of the tread and predictive beneficial reduction in tire rolling resistance for better fuel economy for an associated vehicle.

A further benefit of providing a natural rubber-rich tread is to promote resistance to cut growth initiation (tear resistance), particularly when the tire treads are intended for service over harsh ground conditions such as may be experienced in off-the-road heavy duty service as well as unimproved roadway conditions.

For the beneficial promotion of reduction in hysteresis property for the natural rubber-based tread rubber composition, it may be thought of to employ filler reinforcement for the rubber composed of precipitated silica reinforcement instead of, or with a significantly reduced amount of, rubber reinforcing carbon black.

For the beneficial promotion of increase in abrasion resistance for natural rubber-based rubber compositions for treads of such tires may also be desired to provide a minor amount of cis 1,4-polybutadiene rubber for predictive increase in resistance to tread wear and thereby promote a longer lasting tire service.

For the aforesaid promotion of beneficial resistance to cut growth initiation and cut growth propagation for the natural rubber-based tread rubber composition it may also be thought of employ reinforcing filler composed of precipitated silica instead of, or with a significantly reduced amount of rubber reinforcing carbon black.

However, such use of precipitated silica for the natural rubber-based tread rubber filler reinforcement for the tread rubber without including rubber reinforcing carbon black might be expected to promote a reduction in abrasion resistance and therefore promote a reduction in resistance to tread wear for which the aforesaid inclusion of a minor amount of cis 1,4-polybutadiene rubber may be appropriate to regain a degree of abrasion resistance for the tread rubber composition.

A challenge remains, however, of promoting an improvement (reduction) in hysteresis of the tread rubber composition with its aforesaid promotion of reduction in rate of internal heat generation without reducing a resistance to cut growth initiation (tear resistance) of the tread rubber during such mixed service.

For such challenge for the silica-rich natural rubber based tire tread, it has been discovered that use of precipitated silica reinforcement comprised of a bimodal aggregate size distribution together with a monomodal pore size distribution can be used to promote a beneficial reduction in hysteresis together with a beneficial increase in resistance to cut growth initiation and propagation (sometimes referred to as tear resistance) for the tread composition intended for use in such mixed service conditions.

It is believed that use of such bimodal aggregate size configured precipitated silica reinforcement is a departure from past practice for use in a silica-rich, natural rubber-rich tread rubber composition intended for the aforesaid mixed service where a reduced hysteresis is desired together with resistance to abrasion and resistance to cut initiation are also desired.

For the mixed service tread of a natural rubber rich tread rubber composition, it is further desired to evaluate providing an inclusion of a minor amount of at least one of cis 1,4-polybutadiene rubber and low Tg styrene/butadiene rubber (SBR) to aid in promoting abrasion resistance while substantially maintaining hysteresis and cut growth initiation (tear resistance) properties of the tread rubber. For such purpose, it is desired that the SBR has a relatively low styrene content in a range of from about 12 to about 20 percent to promote a low Tg (glass transition temperature) property of the SBR in a range of, for example, from about −68° C. to about −72° C.

In order to meet minimal requirements for such mixed service tire treads, the following combination of threshold physical properties are desired for the tire tread rubber composition as presented in the following Table A. For this invention, however, it is desired to evaluate providing a tread rubber composition with enhanced physical properties which exceed the threshold physical properties of Table A.

TABLE A

| Properties—various | |
|---|---|
| test methods are described in the Examples | Threshold Values |
| 1. Storage modulus (G'), MPa | >=1.01 |
| (10% strain, 1 Hertz, 100° C.) | |
| 2. Tan delta, (10% strain, 1 Hertz, 100° C.) | <0.250 |
| 3. Rebound, hot (100° C.) | >=55 |
| 4. Grosch abrasion rate, high severity (mg/km) | <=1000 |
| 5. Tear resistance (N) | >125 |
| 6. Toughness = ratio of specific energy to | |
| break (joules)/300% modulus (MPa) | >=500 |

In the description of this invention, terms such as “compounded rubber”, “rubber compound” and “compound”, if used herein, refer to rubber compositions containing of at least one elastomer blended with various ingredients, including curatives such as sulfur and cure accelerators. The terms “elastomer” and “rubber” may be used herein interchangeably unless otherwise indicated. It is believed that such terms are well known to those having skill in such art. Number and weight average molecular weights of an elastomer, if referenced, may be determined by, for example, by gel permeation chromatography (GPC) analytical equipment usually combined with a light scattering detector, a methodology known to those having skill in the polymer analytical art. The glass transition temperature (Tg) of a rubber may be determined by differential scanning calorimetry according to ASTM D3418-12.

### DISCLOSURE AND PRACTICE OF THE INVENTION

In accordance with this invention, a rubber composition is provided which is comprised of, based on parts by weight per 100 parts by weight of elastomer (phr),

(A) conjugated diene-based elastomers comprised of
(1) about 55 to about 80, alternately about 60 to about 80, phr of cis 1,4-polyisoprene rubber comprised of natural or synthetic, desirably natural, cis 1,4-polyisoprene rubber,
(2) about 20 to about 45, alternately from 20 up to 40, phr of at least one of cis 1,4-polybutadiene rubber and organic solution polymerization prepared styrene/butadiene rubber (S-SBR) having a bound styrene content in a range of from about 12 to about 20 percent,

(B) about 40 to about 120, alternatively about 50 to about 100, phr of rubber reinforcing filler comprised of a combination of rubber reinforcing carbon black and precipitated silica (synthetic amorphous precipitated silica), wherein said reinforcing filler is comprised of from about 2 to about 50, alternately from about 4 to about 40 phr of rubber reinforcing carbon black, and from about 38 to about 118, alternately from about 46 to about 96, phr of precipitated silica together with silica coupling agent (for said precipitated silica) having a moiety reactive with hydroxyl groups (e.g. silanol groups) on said precipitated silica and another different moiety interactive with carbon-to-carbon double bonds of said conjugated diene-based elastomers;

wherein the precipitated silica is comprised of a bimodal aggregate size configured precipitated silica with a monomodal pore size distribution;

wherein said bimodal aggregate sized precipitated silica is comprised of about a 60 to about 80 percent of an average aggregate size configuration in a range of from about 0.05 to about 0.11 microns (about 50 to about 110 nm) and about 20 to about 40 percent of an average size configuration in a range of from about 0.12 to about 1 micron (about 120 to about 1,000 nm).

In one embodiment, said precipitated silica may also contain from about 2 to about 20 weight percent thereof of a monomodal aggregate sized precipitated silica, if desired and appropriate.

For the elastomers in one embodiment, the cis 1,4-polybutadiene rubber has a cis 1,4-isomeric content of at least about 95 percent.

For the elastomers, it is important to appreciate that the low styrene content of the S-SBR in a range of from about 12 to about 20 percent is provided to promote the S-SBR with a low Tg in a range of from about −68° C. to about −72° C. This distinguishes the S-SBR for this invention from S-SBR's with higher styrene contents and from emulsion (aqueous emulsion) polymerization derived styrene/butadiene rubber (E-SBR) which would be normally be expected to have a bound styrene content of about 23.5 percent and a Tg in a range of from about −48° C. to about −52° C.

In one embodiment, said S-SBR may be a functionalized styrene/butadiene rubber containing at least of one of end-functional and in-functional terminal functional groups desirably comprised of siloxy and at least one of amine and thiol groups reactive with hydroxyl groups on the bimodal aggregate sized precipitated silica (and on the additional monomodal aggregate sized precipitated silica if used).

In one embodiment, said functionalized S-SBR may be tin coupled (a tin coupled functionalized S-SBR).

In one embodiment, the diene based elastomer in addition to the cis 1,4-polyisoprene rubber is the cis 1,4-polybutadiene rubber.

In one embodiment, the diene based elastomer in addition to the cis 1,4-polyisoprene rubber is the S-SBR having a Tg in a range of from about −68° to about −72°.

In one embodiment, said diene based elastomer in addition to the cis 1,4-polyisoprene rubber is a combination of the cis 1,4-polybutadiene rubber and S-SBR rubber.

In further accordance with this invention, a pneumatic rubber tire is provided having a tread comprised of said rubber composition comprised of the combination of dispersion of bimodal aggregate sized precipitated silica and the aforesaid diene-based elastomers, particularly a tire intended for the aforesaid mixed service such as a combination of on-the-road and off-the-road service.

In one embodiment, the bimodal aggregate sized precipitated silica aggregates has a relatively high average nitrogen surface area of greater than 190 m²/g. Further, in one embodiment, the bimodal aggregate sized precipitated silica has a relatively narrow average monomodal pore size distribution in a range of from about 13 to about 23 nanometers (nm) as determined by mercury porisometry.

The nitrogen surface area may be determined, for example, by the Brauner-Emmitt-Kelly method (American Chemical Society, v.60, year 1938).

As indicated, the pore size of the bimodal aggregated sized precipitated silica is of a monomodal average sized precipitated silica aggregates, as measured by mercury porisometry.

Monomodal is used herein to mean a single peak in a graphical depiction.

The bimodal size configured precipitated silica aggregates for use in this invention are acidic in nature in the sense of having a pH in a range of from about 3 to about 5.6 in contrast to what is believed to be a more normal pH in a range of from about 6 to about 8 for a monomodal aggregate size configured precipitated silica.

In one embodiment, said bimodal sized precipitated silica aggregates and silica coupling agent may be provided individually (contained individually) in the rubber composition and thereby react together in situ within the rubber composition or may be provided (contained in said rubber composition) as a pre-formed composite (pre-formed prior to addition to said rubber composition) of said precipitated silica (comprised of said bimodal aggregate sized precipitated silica) and silica coupling agent reacted together and the composite added to the rubber composition.

In one embodiment, the cis 1,4-polybutadiene rubber is comprised of at least one of:

(A) a first specialized cis 1,4-polybutadiene rubber having a microstructure comprised of from about 90 to about 99 percent cis 1,4-isomeric units, a number average molecular weight (Mn) in a range of from about 120,000 to about 300,000 and a heterogeneity index (Mw/Mn) in a range of from about 2.1/1 to about 4.5/1 (a relatively high heterogeneity index range illustrating a significant disparity between its number average and weight average molecular weights), or

(B) a second specialized cis 1,4-polybutadiene rubber having a microstructure comprised of from about 93 to about 99 percent cis 1,4-isomeric units, a number average molecular weight (Mn) in a range of from about 150,000 to about 300,000 and a heterogeneity index (Mw/Mn) in a range of from about 1.5/1 to about 2/1 (a relatively moderate heterogeneity index range illustrating a moderate disparity between its number average and weight average molecular weights).

In one embodiment, said first specialized cis 1,4-polybutadiene rubber may be the product of a nickel or cobalt catalyst promoted polymerization of 1,3-butadiene monomer in an organic solvent solution. For example, U.S. Pat. No. 5,451,646 illustrates nickel catalyzed polymerization of 1,3-butadiene monomer with a catalyst system comprised of, for example, a combination of an organonickel compound (e.g. nickel salt of a carboxylic acid), organoaluminum compound (e.g. trialkylaluminum) and fluoride containing compound (e.g. hydrogen fluoride or complex thereof).

Representative of said first specialized cis 1,4-polybutadiene elastomer is, for example, Budene 1207™ from The Goodyear Tire & Rubber Company.

In one embodiment, the cis 1,4-polybutadiene elastomer may be tin coupled to provide branched, higher molecular weight, cis 1,4-polybutadiene.

Representative of such tin coupled, branched, cis 1,4-polyutadine elastomer is, for example, Budene 4001™ from The Goodyear Tire & Rubber Company.

In one embodiment, said second specialized cis 1,4-polybutadiene rubber may be the product of a neodymium or titanium catalyst promoted polymerization of 1,3-butadiene monomer in an organic solvent. For example, 1,3-butadiene monomer may be polymerized in an organic solvent solution in the presence of a catalyst system comprised of, for example, organoaluminum compound, organometallic compound such as for example neodymium and labile (e.g. vinyl) halide described in, for example and not intended to be limiting, U.S. Pat. No. 4,663,405 for the neodymium catalyzed polymerization.

Representative of neodymium compounds might be, for example, neodymium neodecanoate, neodymium octanoate or neodymium versalate. The neodymium compounds might be derived from a neodymium carboxylate soap such as, for example Nd(R—C00)₃. Representative of aluminum alkyl compounds may be, for example, triisobutylaluminum (TIBA) and diisobutylaluminum hydride (DIBAH). Representative of aluminum chloride delivering compounds may be, for example, diethylaluminum chloride, all so long as the specialized polybutadiene elastomer possesses the aforesaid microstructure, molecular weight and heterogeneity index and Tg ranges.

Therefore, the catalyst for preparation of said second specialized polybutadiene elastomer is exclusive of cobalt or nickel based catalysts used for preparation of cis 1,4-polybutadiene elastomers.

A purpose for the use of the second specialized polybutadiene may be to promote higher rebound values for the rubber composition which is predictive of less internal heat generation, and therefore less temperature build-up for the rubber composition when it is being worked and predictive of better (lower) rolling resistance for a tire with a tread of such rubber composition which contains the specialized polybutadiene rubber. A further purpose is to promote greater abrasion resistance of the rubber composition which is predictive of better resistance to tread wear for a tire with such rubber composition in which the polybutadiene elastomer is the second specialized polybutadiene elastomer.

Representative of said second specialized cis 1,4-polybutadiene elastomer for use in this invention as 1,3-butadiene polymerized with a neodymium based catalysis is, for example, CB25™ Budene from Lanxess and Budene 1223™ from The Goodyear Tire & Rubber Company.

In one embodiment, the polymer chain of the second specialized polybutadiene elastomer might be coupled (e.g. the polybutadiene rubber being coupled to itself to thereby increase its molecular weight or to promote branching of the elastomer, namely branching of its polymer chain), for example, by treatment with, for example, a sulfur chloride such as, for example, disulfur dichloride as mentioned in U.S. Pat. No. 5,567,784 as would be known to those having skill in such art.

In one embodiment, the tire tread includes an underlying tread base rubber layer (underlying the ground-contacting outer tread rubber layer containing the bimodal aggregate sized precipitated silica dispersion) may be of a rubber composition comprised of, for example, at least one conjugated diene-based elastomer (e.g. cis 1,4-polyisoprene natural rubber) and reinforcing filler comprised of rubber reinforcing carbon black and, optionally, precipitated silica (e.g. monomodal average sized precipitated silica).

The silica coupling agent for the precipitated silica may be comprised of, for example, a bis (3-trialkoxysilylalkyl) polysulfide containing an average in a range of from about 2 to about 3.8, alternately from about 2 to about 2.6 and alternately from about 3 to about 3.8, connecting sulfur atoms in its polysulfidic bridge or an alkoxyorganomercaptosilane.

In one embodiment, said silica coupling agent is said bis(3-trialkoxysilylalkyl) polysulfide comprised of a bis(3-triethoxysilylpropyl) polysulfide.

In one embodiment, said bis(3-triethoxypropyl) polysulfide silica coupling agent contains an average in a range of from about 2 to about 2.6 connecting sulfur atoms in its polysulfidic bridge. Such silica coupling agent with a polysulfidic content to an average of from about 2 to 2.6 connecting sulfur atoms may be particularly useful to promote ease of processing, including mixing, extruding and calendering, the uncured rubber composition.

In one embodiment, the reinforcing filler may be provided as being primarily composed of the bimodal aggregate configured precipitated silica.

The bimodal aggregate configured precipitated silica reinforcement for the rubber composition is a synthetic amorphous silica obtained, for example, by a controlled acidification of a soluble silicate (e.g. sodium silicate).

Historically, various rubber compositions have been proposed to which have been added two or more individual precipitated silicas each of which is composed of different averages of particulate aggregate sizes. For example, see U.S. Pat. No. 6,121,346. It has also been proposed to provide a precipitated silica composed of a dual aggregate configuration. For example, see U.S. Pat. No. 6,225,397.

However for this evaluation, use of an individual precipitated silica is evaluated having a significant increased acidity (low pH) and relatively high nitrogen surface area which is composed of the aforesaid bimodal aggregate size configuration comprised of precipitated silica particles, namely comprised of a first aggregate configuration of from about 60 to about 80 weight percent of the precipitated silica having an average particle size in a range of from about 0.05 to about 0.11 microns and a second aggregate configuration of from about 20 to about 40 weight percent of the precipitated silica having an average particle size in a range of from about 0.12 to about 1 micron.

As previously mentioned, the pore size distribution of the bimodal configured precipitated silica aggregates, as measured by mercury porosimetry is monomodal.

Mercury porosimetry analysis involves measuring surface area of the silica, collectively including pores of the silica aggregates and of the primary particles making up the silica aggregates, where, for example, mercury is allowed to penetrate into the pores of the silica after a thermal treatment to remove volatiles by a method known to those having skill in such art. For example, such method may be performed according to a method reported in DIN 66133 where, for such evaluation, a Carlo-Erba Porosimetry 2000 might be used. A Washburn equation is reported as being employed to calculate pore diameters.

In order to further understand the nature of such bimodal aggregate configured precipitated silica, drawings in a form of graphical representations are provided.

### BRIEF DESCRIPTION OF THE DRAWINGS

FIG. 1 presents individual aggregate size distribution curves for precipitated Silica A and precipitated Silica B.

FIG. 2 presents individual relative and cumulative pore volume curves for aggregates of precipitated Silica A.

FIG. 3 presents individual relative and cumulative pore volume curves for aggregates of precipitated Silica B.

Precipitated Silica A represents a bimodal sized precipitated silica aggregate configuration as Toksil UR™ from Tokuyama Siam. Precipitated Silica B represents a monomodal sized precipitated silica aggregate configuration as Premium 100™ from Solvay.

### IN THE DRAWINGS

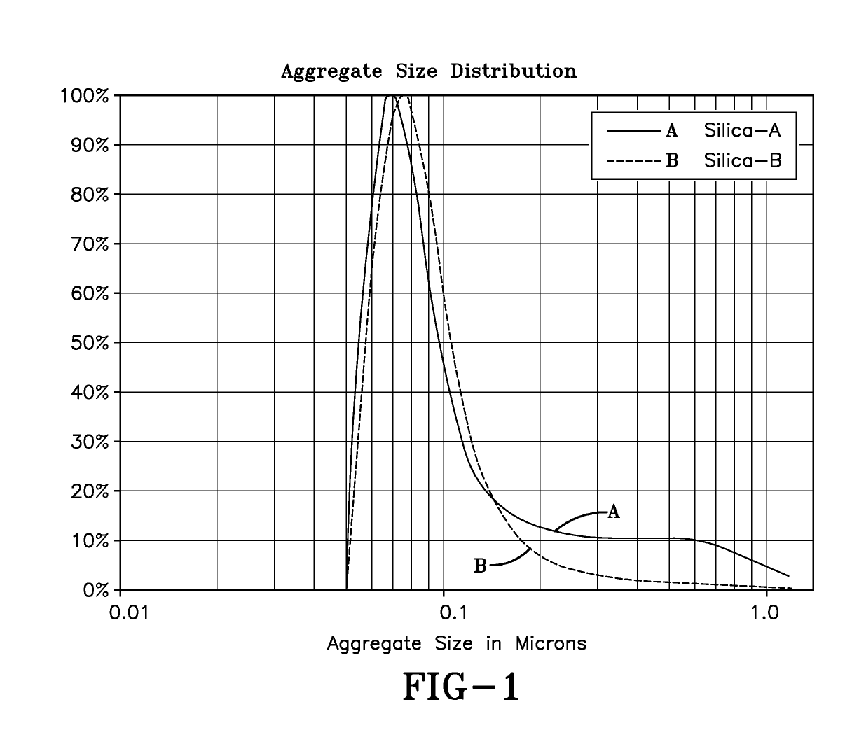

### FIG. 1

FIG. 1 presents curves to illustrate precipitated silica average aggregate sizes for Silica A and for Silica B.

Curve A represents aggregates of precipitated silica A and curve B represents aggregates of precipitated Silica B.

The silica aggregate sizes are plotted on the X axis and the relative weight percentages of the silica aggregates are plotted on the Y axis. The X axis of the curves is presented on a scale of from about 50 to about 1000 nm (nanometers), or about 0.05 to about 1.0 microns.

In FIG. 1 it can be seen that Curve B contains a single, relatively sharp, peak at about 60 nm (at about 0.06 microns), for its aggregate size distribution. This single peak represents a monomodal aggregate size distribution (e.g. configuration) for Silica B.

In FIG. 1 it can also be seen that Curve A contains dual peaks in a form of a first relatively sharp peak at about 80 nanometers (about 0.8 microns) in addition to a second broader less defined peak at about 200 to about 500 nanometers (about 2 to about 0.5 microns), for its aggregate size configuration. This dual peak represents a bimodal aggregate size configuration for Silica A.

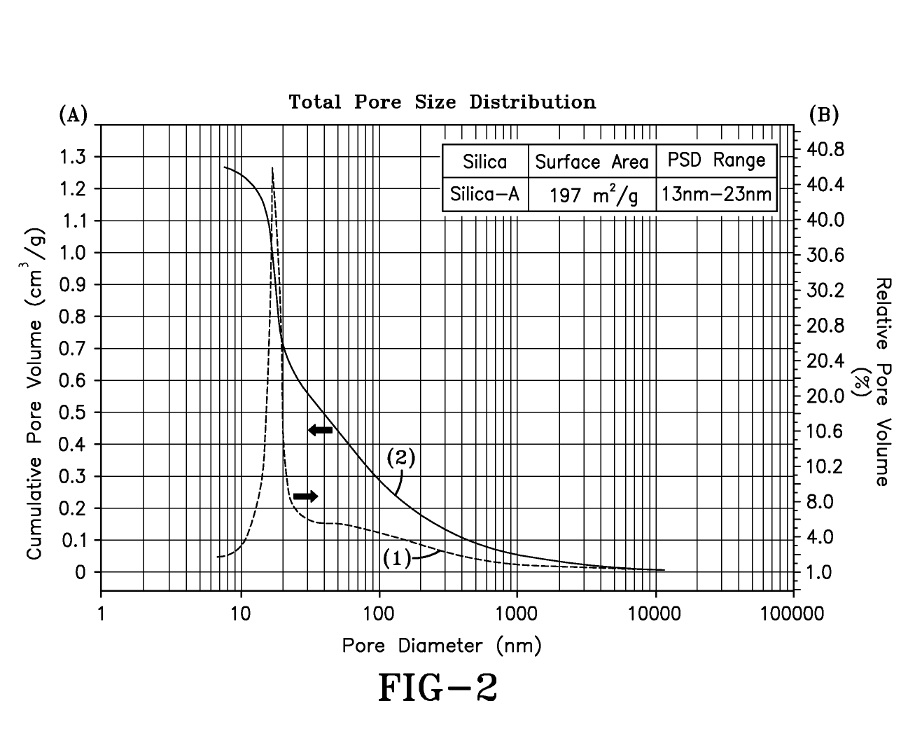

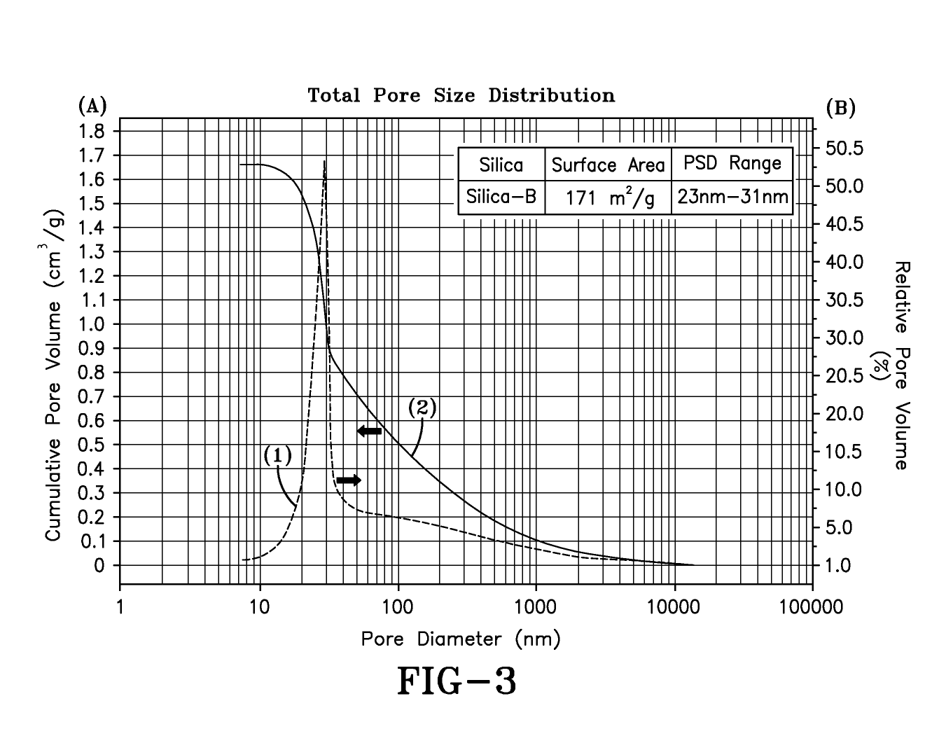

### FIGS. 2 and 3

FIGS. 2 and 3 present curves of (1) Relative Pore Volumes and (2) Cumulative Pore

Volumes for the left and right Y axis versus average pore diameters on the X axis for the aggregates of precipitated Silica A in FIG. 2 and for precipitated Silica B in FIG. 3.

The X axis is presented on a scale of from about 8 to about 10,000 nanometers for the average pore diameters for the precipitated silica aggregates according to mercury porosimetry.

The Y axis (left vertical scale) is presented on a scale of about 0.01 to about 1.25 cc/gram for the average Cumulative Pore Volumes for the precipitated silica aggregates.

The Y axis (right vertical scale) is presented on a scale of about 1 to about 40.5 percent for average relative pore volumes for the precipitated silica aggregates.

Comparison and Conclusions Drawn from the Curves of FIGS. 2 and 3

In FIG. 2, representing precipitated Silica A, it can be seen that Curve (1) (average pore volumes) presents a single peak at about 18 mn which is representative of a monomodal pore size distribution for Silica A.

It is further observed from FIG. 2 that the Curve (1) is a very sharp shaped curve thereby indicating a narrow monomodal pore size configuration for Silica A.

In FIG. 3, representing precipitated Silica B, it can be seen that Curve (1) (average pore volumes) presents a single peak at about 38 nm which is representative of a monomodal pore size distribution for Silica B for a larger average pore size than the pore size of Silica A (in FIG. 2).

It is further observed from FIG. 2 that the Curve (1) is a very sharp shaped curve thereby indicating a narrow monomodal pore size distribution for Silica B.

Therefore, in summary, it is concluded that the aggregates of Silica A are of a bimodal size distribution configuration and that the average pore size of the aggregates of Silica A are of a monomodal configuration.

In FIG. 2, representing precipitated Silica A, the inserted box reports that the aggregates of Silica A were observed to have an average pore size distribution (PSD) in a range of from about 13 to 23 nm (taken from Curve (1) in FIG. 2), and an average nitrogen surface area of about 197 nm.

In FIG. 3, representing precipitated Silica B, the inserted box reports that the aggregates of Silica B were observed to have a significantly larger average pore size distribution (PSD) in a range of from about 23 to 31 nm (taken from Curve (1) in FIG. 3), and a smaller average nitrogen surface area of about 171 nm.

A further distinguishing feature of the bimodal silica aggregate sized Silica A is its acidity, represented by a pH in a range of from about 3 to about 5.6 taken from a water dispersion of Silica A. In contrast Silica B (the monomodal aggregate sized precipitated silica) is represented by a higher pH in a range of from about 6 to about 8 which approximates a more neutral pH.

A significance of the greater acidity of the bimodal aggregate sized Silica A, such as the bimodal configuration sized precipitated silica used for this invention with a pH in a range of from about 3 to about 5.6, is its promotion of longer polysulfidic sulfur cross link chains in a sulfur cured rubber composition which promotes a beneficial increase in tear resistance property (increase in resistance to cut growth initiation property) for the sulfur cured rubber composition in addition to the rubber reinforcing effect of the bimodal aggregate sized precipitated silica.

In a significant contrast, the monomodal aggregate sized silica B is less acidic in a sense of having a typical almost neutral pH in range of from about 6 to about 8 which thereby presents a tendency of promotion of shorter polysulfidic chains in a sulfur cured rubber composition and thereby a promotion of a lesser tear resistance property (a less cut growth initiation property) for the sulfur cured rubber composition.

It would be readily understood by those having skill in the art that the natural rubber-rich tread for the aforesaid mixed service use conditions, which also contain a minor amount of the at least one of the polybutadiene and low styrene containing S-SBR elastomers, would be compounded with conventional compounding ingredients including the aforesaid reinforcing fillers such as carbon black and precipitated silica, although this invention would require the precipitated silica with bimodal aggregate configuration with monomodal pore size distribution and low pH, as well as antidegradant(s), processing oil, fatty acid comprised of, for example, at least one of stearic, oleic, palmitic, and possibly linolenic, acids, zinc oxide, sulfur cure materials including sulfur and vulcanization accelerator(s).

Processing aids may be used, for example, waxes such as microcrystalline and paraffinic waxes, in a range, for example, of about 1 to 5 phr or about 1 to about 3 phr, if used; and resins, usually as tackifiers, such as, for example, synthetic hydrocarbon and natural resins in a range of, for example, about 1 to 5 phr or about 1 to about 3 phr, if used. A curative might be classified as sulfur together with one or more sulfur cure accelerator(s). For the sulfur and accelerator(s) curatives, the amount of sulfur used may be, for example, from about 0.5 about 5 phr, more usually in a range of about 0.5 to about 3 phr; and the accelerator(s), often of the sulfenamide type, is (are) used in a range of about 0.5 to about 5 phr, often in a range of about 1 to about 2 phr. The ingredients, including the elastomers but exclusive of sulfur and accelerator curatives, are normally first mixed together in a series of at least two sequential mixing stages, although sometimes one mixing stage might be used, to a temperature in a range of, for example, about 145° C. to about 185° C., and such mixing stages are typically referred to as non-productive mixing stages. Thereafter, the sulfur and accelerators, and possibly one or more retarders and possibly one or more antidegradants, are mixed therewith to a temperature of, for example, about 90° C. to about 120° C. and is typically referred as a productive mix stage. Such mixing procedure is well known to those having skill in such art.

After mixing, the compounded rubber can be fabricated such as, for example, by extrusion through a suitable die to form a tire tread. The tire tread is then typically built onto a sulfur curable tire carcass to form an assembly thereof and the assembly thereof cured in a suitable mold under conditions of elevated temperature and pressure by methods well known to those having skill in such art.

The invention may be further understood by reference to the following example in which the parts and percentages are by weight unless otherwise indicated.

### EXAMPLE I

Rubber compositions were prepared to evaluate their use as a tread rubber for a mixed service tire intended for high severity use.

Rubber compositions are referred in this Example as Control (Comparative) rubber Samples 1 through 4 together with Experimental rubber Samples A through E.

Control (Comparative) rubber Sample 1 is composed of natural rubber which contains filler reinforcement in a form of rubber reinforcing carbon black N120.

Control (Comparative) rubber Sample 2 is comprised of a combination of natural rubber and emulsion polymerization prepared styrene/butadiene rubber (E-SBR) which contains filler reinforcement in a form of rubber reinforcing carbon black N220.

Experimental rubber Sample A is similar to Control (Comparative) rubber Sample 1 except that it contains the bimodal aggregate size configuration precipitated silica such as Toksil UR silica represented by Curve A of FIG. 1 rather than a monomodal aggregate size configuration precipitated silica such as Zeosil Premium 200™ silica from Solvay similar to Curve B of FIG. 1.

Control (Comparative) rubber Sample 3 is comprised of natural rubber (cis 1,4-polyisoprene rubber) which contains reinforcing filler in a form of highly dispersible precipitated silica such as Zeosil 8755LS™ from Solvay (of a monomodal aggregate size configuration similar Curve B of FIG. 1). The rubber composition contains only a trace amount of carbon black for cosmetic colorant purposes.

Experimental rubber Sample B is similar to Control (Comparative) rubber Sample 3 except that it has bimodal aggregate size configured precipitated silica such as Toksil UR silica rather than a more conventional monomodal aggregate size configuration as a high dispersible precipitated silica such as Zeopol 8755LS™ from Huber. The rubber composition contains only a trace amount of carbon black primarily for cosmetic purposes.

Control (Comparative) rubber Sample 4 is comprised of a combination of natural rubber, organic solvent solution polymerization derived styrene/butadiene rubber (S-SBR) and cis 1,4-polybutadiene rubber which contains reinforcing filler in a form of high surface area, highly dispersible monomodal aggregate size configuration precipitated silica as Zeosil Premium 200™ from Solvay and rubber reinforcing carbon black (N212). In addition, its cure system was modified to be consistent with Control rubber Sample 4.

Experimental rubber Sample D is similar to Control (Comparative) rubber Sample 4 except that its reinforcing filler is a bimodal aggregate size configured precipitated silica such as Toksil UR silica.

In a summary, only the Experimental rubber Samples (A, B, C and D) contain reinforcing filler as the bimodal aggregate size configured precipitated silica. It is sometimes used as the only reinforcing filler (Sample B) and sometimes combined with rubber reinforcing carbon black (Experimental rubber Samples A and D). It might be used, for example, in a rubber composition where its elastomer content is 100 percent polyisoprene rubber (Experimental rubber Sample B) or in a rubber composition which contains a significant amount of other diene-based elastomers, such as polybutadiene and S-SBR elastomers, (Experimental rubber Sample D).

The basic rubber composition formulation is shown in Table 1 and the ingredients are expressed in parts by weight per 100 parts rubber (phr) unless otherwise indicated.

The rubber compositions may be prepared, for example, by mixing the elastomers(s) without sulfur and sulfur cure accelerators in a non-productive mixing stage (NP) in an internal rubber mixer for about 4 minutes to a temperature of about 160° C. If desired, the rubber mixture may then mixed in a second non-productive mixing stage (NP-2) in an internal rubber mixer for about 4 minutes to a temperature of about 160° C. with or without adding additional ingredients. The resulting rubber mixture may then mixed in a productive mixing stage (PR) in an internal rubber mixer with sulfur and sulfur cure accelerator(s) for about 2 minutes to a temperature of about 110° C. The rubber composition may then sheeted out and cooled to below 50° C. between each of the non-productive mixing steps and prior to the productive mixing step. Such rubber mixing procedure is well known to those having skill in such art.

TABLE 1

| | Parts (phr) |
|---|---|
| | Control |
| Non-Productive Mixing Step (NP1) | |
| Elastomer(s)¹ | 100 |
| Carbon black, rubber reinforcing² | 0 to 35 |
| Silica, precipitated³ | 0 to 45 |
| Silica coupling agent as a 50/50 carbon black composite⁴ | 0 to 11.25 |
| Oil, rubber processing | 0 to 4 |
| Wax microcrystalline and paraffin | 0.5 to 2 |
| Fatty acids⁵ | 2 to 4 |
| Antioxidants | 2.5 to 4 |
| Zinc oxide | 3 |
| Productive Mixing Step (PR) | |
| Sulfur | 0.9 to 1.2 |
| Accelerator(s)⁶ | 0.8 to 1.6 |

¹Elastomers selected from natural rubber, styrene/butadiene rubber (S-SBR) and cis 1,4-polybutadiene rubber
²N220, N120 or N121 which are ASTM designations
³Bimodal aggregate sized configured and monomodal aggregate sized configured precipitated silica
⁴Composite of silica coupling agent and carbon black (carrier for the coupling agent) in a 50/50 weight ratio where said coupling agent is comprised of bis(3-triethoxysilylpropyl) polysulfide having an average of from about 2 to about 2.6 connecting sulfur atoms in its polysulfidic bridge as Si266 ™ from Evonik. Therefore, a composite of 11 phr would be comprised of 50 percent, or about 5.5 phr, of rubber reinforcing carbon black.
⁵Mixture comprised of stearic, palmitic and oleic acids
⁶Sulfur cure accelerators

The following Table 2 is a summary of the Control and Experimental rubber Samples reflecting the elastomers and reinforcing filler used. The amounts are reported in terms of parts by weight per 100 parts by weight rubber (phr).

TABLE 2

| | Parts by Weight (phr) | | | | | | | |
|---|---|---|---|---|---|---|---|---|
| Materials | Cntl 1 | Cntl 2 | Exp A | Exp B | Cntl 3 | Exp C | Exp D | Cntl 4 |
| Natural rubber¹ | 100 | 80 | 80 | 100 | 100 | 80 | 60 | 60 |
| S-SBR rubber² | 0 | 0 | 0 | 0 | 0 | 20 | 16 | 16 |
| E-SBR rubber³ | 0 | 20 | 20 | 0 | 0 | 0 | 0 | 0 |
| Polybutadiene rubber⁴ | 0 | 0 | 0 | 0 | 0 | 0 | 24 | 24 |
| Carbon black (N220)⁵ | 0 | 48 | 0 | 0 | 0 | 0 | 0 | 0 |
| Carbon black (N120)⁶ | 43 | 0 | 35 | 0 | 0 | 35 | 0 | 0 |
| Carbon black (N121)⁷ | 0 | 0 | 0 | 0 | 0 | 0 | 26 | 26 |
| Bimodal precipitated silica (A)⁸ | 0 | 0 | 15 | 45 | 0 | 15 | 23 | 0 |
| Monomodal precipitated silica (B)⁹ | 9 | 0 | 0 | 0 | 0 | 0 | 0 | 0 |
| Monomodal precipitated silica (C)¹⁰ | 0 | 0 | 0 | 0 | 45 | 0 | 0 | 0 |
| Monomodal precipitated silica (D)¹¹ | 0 | 0 | 0 | 0 | 0 | 0 | 0 | 23 |
| Sulfur curative (sulfur)¹² | 0.9 | 1.2 | 1.2 | 1 | 1 | 1 | 1.2 | 1.2 |
| Sulfur cure accelerator¹³ | 0.9 | 1 | 1.6 | 1.4 | 2 | 2.5 | 2 | 2 |

¹Natural cis 1,4-polyisoprene rubber
²Organic solvent polymerization prepared S-SBR (polymerization of styrene and 1,3-butadiene monomers) containing about 18.5 percent bound styrene as Solflex ™ 18B10 from The Goodyear Tire & Rubber Company
³Emulsion (aqueous) polymerization prepared styrene/butadiene rubber (E-SBR) containing about 23 percent bound styrene as Plioflex ™ 1502 from The Goodyear Tire & Rubber Company
⁴Cis 1,4-polybtadiene rubber as Budene4001 ™ from The Goodyear Tire and Rubber Company
⁵Carbon black as N220, reportedly having an iodine absorption value of about 121 g/kg (ASTM D1510) and dibutyl phthalate (DBP) adsorption value of about 114 cc/100 g (ASTM D2414)
⁶Carbon black as N120, reportedly having an iodine absorption value of about 122 g/kg (ASTM D1510) and dibutyl phthalate (DBP) adsorption value of about 114 cc/100 g (ASTM D2414)
⁷Carbon black as N121, reportedly having an iodine absorption value of about 121 g/kg (ASTM D1510) and dibutyl phthalate (DBP) adsorption value of about 130 cc/100 g (ASTM D2414)
⁸Bimodal aggregate size configured precipitated silica configured with about 80 percent aggregates having an average aggregate size of about 0.07 microns and with about 20 percent aggregates having an average aggregate size of about 0.5 microns, with monomodal pore size by mercury porosimetry, with an acidity (pH) of about 5 and a nitrogen surface area greater than 190 square meters per gram as Tokusil UR from Tokuyama Siam Company
⁹Precipiated silica as Zeosil 125GR ™ from Solvay
¹⁰Precipitated silica as Zeosil 8755LS ™ from Solvay
¹¹Precipitated silica as Zeosil Premium 200 from Solvay
¹²Insoluble sulfur
¹³Sulfur cure accelerator(s) as a combination of sulfenamide and diphenyl guanidine sulfur cure accelerators

Various physical properties of the rubber compositions are reported in the following Table 3. The physical properties of the Control 1 rubber sample are each reduced to a value of 100 and corresponding physical properties of the remainder of the rubber samples are normalized to the physical properties of 100 for the Control 1 rubber sample. The physical properties of the Control 1 rubber sample exhibit at least the threshold values reported in Table A.

TABLE 3

| | Parts by Weight | | | | | | | |
|---|---|---|---|---|---|---|---|---|
| Property | Cntl 1 | Cntl 2 | Exp A | Exp B | Cntl 3 | Exp C | Exp D | Cntl 4 |
| Storage modulus G′, MPa (1) | 100 | 77 | 137 | 118 | 87 | 72 | 110 | 118 |
| Tan delta (2) | 100 | 135 | 60 | 82 | 81 | 91 | 90 | 92 |
| Hot rebound (100° C.) | 100 | 86 | 112 | 99 | 127 | 104 | 118 | 102 |
| Toughness (3) | 100 | 143 | 149 | 212 | 85 | 343 | 140 | 82 |
| Grosch medium abrasion rate (4) | 100 | 106 | 108 | 122 | 100 | 66 | 87 | 80 |
| Grosch high abrasion rate (5) | 100 | 152 | 141 | 154 | 125 | 119 | 75 | 77 |
| Tear resistance (6) | 100 | 153 | 142 | 145 | 61 | 201 | 100 | 63 |
| Tear resistance, aged (7) | 100 | 166 | 124 | 132 | 86 | 122 | 99 | 66 |

(1) Conditions: 10 percent strain, 1 Hertz, 100° C.—lower value is better for reduced hysteresis
(2) Conditions: 10 percent strain, 1 Hertz, 100° C.—higher value is better for reduced hysteresis
(3) Toughness is a ratio of specific energy to break the rubber (joules) over static 300 percent modulus—higher values are better as an indication of better chip-chunk resistance of the rubber composition for the tire tread. Specific energy to break the rubber and 300 percent modulus values were obtained using a standard test to determine properties of vulcanized dumbbell shaped rubber samples described in ASTM D412-06A.
(4) Grosch rate of abrasion (mg/km) medium severity—lower is better, as a lower abrasion rate
(5) Grosch rate of abrasion (mg/km) high severity—lower is better, as a lower abrasion rate

The Grosch abrasion rate run may be on an LAT-100 Abrader and is measured in terms of mg/km of rubber abraded away. The test rubber sample is placed at a slip angle under constant load (Newtons) as it traverses a given distance on a rotating abrasive disk (disk from HB Schleifmittel GmbH). In practice, a low abrasion severity test may be run, for example, at a load of 20 Newtons, 2 degree slip angle, disk speed of 40 km/hr for a distance of 7,500 meters; a medium abrasion severity test may be run, for example, at a load of 40 Newtons, 6 degree slip angle, disk speed of 20 km/hr and distance of 1,000 meters; a high abrasion severity test may be run, for example, at a load of 70 Newtons, 12 degree slip angle, disk speed of 20 km/hr and distance of 250 meters; and an ultra high abrasion severity test may be run, for example, at a load of 70 Newtons, 16 degree slip angle, disk speed of 20 km/hr and distance of 500 meters.

The tear resistance, a measure of resistance to cut growth initiation (sometimes referred to as tear strength) can be obtained by a tear resistance test. The test may be administered and reported, for example, by ASTM D1876-01 taken with DIN 53539 using a 5 mm wide tear width provided by a longitudinal open space, sometimes referred to as a window, cut or otherwise provided, in a film positioned between the two rubber test pieces where a window is provided in the test piece. Therefore, a composite is provided of the two pressed and sulfur cured together rubber samples with the film therebetween, (viewed through the window) which provides a geometrically defined area, sometimes referred to as a tear width, for portions of two rubber test pieces to be pressed and cured together after which the ends of the two test pieces are pulled apart at right angles (90°+90°=180°) and the force to pull the test pieces apart is measured. The size of the test rubber pieces is about 150×25 mm and the window is about 50×5 mm. An Instron instrument may be used to pull the rubber pieces apart and measure the force, usually in Newtons force.

For the aged tear resistance, the rubber composite is aged for seven 7 days at 70° C. under atmospheric conditions.

From Table 3 it can be seen that the bimodal sized aggregate configured precipitated silica (with a combination of high nitrogen surface area of greater than 190 m²/g, monomodal pore size distribution and lower pH of about 5.5, thereby of a higher acidity as compared to other monomodal precipitated silicas) which was used in Experimental rubber Samples B, C and D) led to rubber compositions containing beneficially higher rebound physical properties (beneficially lower hysteresis and thereby beneficially lower predictive internal heat build-up during service) and beneficially higher tear resistance with, however, a reduction in abrasion resistance.

A significant discovery is presented by Experimental rubber Sample D containing the bimodal aggregate sized precipitated silica which illustrates a of special benefit of achieving a beneficial reduction in rate of abrasion combined with a beneficial increase in both tear resistance and toughness.

Also, in particular, use of the bimodal aggregate sized precipitated silica (for Experimental rubber Sample D) resulted in higher rebound physical property (indicative of beneficially lower hysteresis and beneficially lower internal heat generation during service) as well as beneficial increase in tear resistance and toughness properties, particularly in comparison to Control rubber Sample 4.

This is considered as being significant in a sense of being a discovery of providing a rubber composition (Experimental rubber Sample D for achieving improved hot rebound physical property and tan delta physical property which is indicative of beneficially lower hysteresis and associated beneficial predictive internal heat generation during service while beneficially improving the rubber's toughness and substantially maintaining, and possibly even improving, both cut growth resistance and abrasion resistance for the rubber composition by providing a balance between elastomers and filler reinforcement. It is considered that such balance of physical properties are important for a tire tread for the diverse mixed service use. Further, tires with treads of such rubber composition would be expected to have beneficial lower rolling resistances, resulting in increased fuel consumption for an associated vehicle. In addition, better durability of a tire carcass would be expected with reinforcement composed of a blend of the bimodal aggregate configured precipitated silica and rubber reinforcing carbon black because of the predictive lower internal heat generation during service. Such predictive lower internal heat generation with beneficially increased tear resistance and toughness values are readily predictive of beneficially better tire overall performance during mixed service operations, particularly during more severe operating conditions such as, for example, off-the-road service.

For clarification purposes, the data for the physical properties Table 3 is selectively repeated in the following Tables.

Here, Tables 4-A and 4-B are provided to depict Control rubber Samples 1 and 2 and Experimental rubber Sample A. For Table 4-B, the Control rubber Sample 1 has its physical properties reduced to a value of 100 and the physical properties of the other rubber samples in the Table 4-B have their values normalized to the value of 100 of the corresponding physical property of Control 1 rubber Sample.

TABLE 4-A

| | Parts by Weight (phr) | | |
|---|---|---|---|
| Materials | Control 1 | Control 2 | Experimental A |
| Natural rubber¹ | 100 | 80 | 80 |
| E-SBR rubber³ | 0 | 20 | 20 |
| Polybutadiene rubber⁴ | 0 | 0 | 0 |
| Carbon black (N220)⁵ | 0 | 48 | 0 |
| Carbon black (N120)⁶ | 43 | 0 | 35 |
| Bimodal precipitated silica (A)⁸ | 0 | 0 | 15 |
| Monomodal precipitated silica (B)⁹ | 9 | 0 | 0 |
| Sulfur curative (sulfur)¹² | 0.9 | 1.2 | 1.2 |
| Sulfur cure accelerator¹³ | 0.9 | 1 | 1.6 |

TABLE 4-B

| Property | Control 1 | Control 2 | Experimental A |
|---|---|---|---|
| Storage modulus G′, MPa¹ | 100 | 77 | 137 |
| Tan delta² | 100 | 135 | 60 |
| Hot rebound (100° C.) | 100 | 86 | 112 |
| Toughness³ | 100 | 143 | 149 |
| Grosch medium abrasion⁴ | 100 | 106 | 108 |
| Grosch high Abrasion⁵ | 100 | 152 | 141 |
| Tear resistance⁶ | 100 | 153 | 142 |
| Tear resistance, aged⁷ | 110 | 166 | 124 |

From Table 4-B it is seen that the rubber hysteresis beneficially increased for the Experimental A rubber sample which used reinforcing filler as the bimodal size configured precipitated silica (as indicated by the increase in hot rebound and reduction of tan delta physical properties). The tear resistance also beneficially increased as did the toughness property. However, the rate of abrasion values (Grosch abrasion rates) were particularly high for the Experimental A rubber sample and reasonably outside of the aforesaid threshold Grosch high severity rate of abrasion of Table A.

Tables 5-A and 5-B are provided to illustrate Control rubber Samples 1 and 3 and Experimental rubber Sample B. For Table 5-B, the Control rubber Sample 1 has its physical properties reduced to a value of 100 and the physical properties of the other rubber Samples in the Table 5-B have their values normalized to the value of 100 of the corresponding physical property of Control 1 rubber Sample.

TABLE 5A

| | Parts by Weight (phr) | | |
|---|---|---|---|
| Materials | Control 1 | Experimental B | Control 3 |
| Natural rubber¹ | 100 | 80 | 80 |
| Natural rubber¹ | 100 | 100 | 100 |
| Carbon black (N120)⁶ | 43 | 0 | 0 |
| Bimodal precipitated silica (A)⁸ | 0 | 45 | 0 |
| Monomodal precipitated silica (B)⁹ | 9 | 0 | 0 |
| Monomodal precipitated silica (C)¹⁰ | 0 | 0 | 45 |
| Sulfur curative (sulfur)¹² | 0.9 | 1 | 1 |
| Sulfur cure accelerator¹³ | 0.9 | 1.4 | 2 |

TABLE 5-B

| Property | Control 1 | Experimental B | Control 2 |
|---|---|---|---|
| Storage modulus G′, MPa¹ | 100 | 118 | 87 |
| Tan delta² | 100 | 82 | 81 |
| Hot rebound (100° C.) | 100 | 99 | 127 |
| Toughness³ | 100 | 212 | 85 |
| Grosch medium abrasion⁴ | 100 | 122 | 100 |
| Grosch high abrasion⁵ | 100 | 154 | 125 |
| Tear resistance⁶ | 100 | 145 | 61 |
| Tear resistance, aged⁷ | 100 | 132 | 86 |

From Table 5-B it can be seen that the hysteresis for Experimental rubber Sample B (to which the bimodal aggregate sized precipitated silica was added and for which the N120 carbon black was used) was similar to Control 1 rubber sample (as indicated by hot rebound and tan delta rubber property values). However the tear resistance values were greatly and beneficially increased as well as the toughness value. However the rate of abrasion for Experimental B rubber sample was particularly high and reasonably outside of the aforesaid threshold Grosch high severity rate of abrasion of Table A.

Tables 6-A and 6-B are provided to illustrate Control rubber Samples 1 and 4 and Experimental rubber Samples B and D. For Table 6-B, the Control rubber Sample 1 has its physical properties reduced to a value of 100 and the physical properties of the other rubber Samples in the Table 5-B have their values normalized to the value of 100 of the corresponding physical property of Control 1 rubber sample.

TABLE 6-A

| | Parts byWeight (phr) | | | |
|---|---|---|---|---|
| | | Experi- | Experi- | |
| Materials | Control 1 | mental B | mental D | Control 4 |
| Natural rubber | 100 | 100 | 60 | 60 |
| S-SBR rubber² | 0 | 0 | 16 | 16 |
| Polybutadiene rubber⁴ | 0 | 0 | 24 | 24 |
| Carbon black (N120)⁶ | 43 | 0 | 0 | 0 |
| Carbon black (N121)⁷ | 0 | 0 | 26 | 26 |
| Bimodal precipitated | 0 | 45 | 23 | 0 |
| silica (A)⁸ | | | | |
| Monomodal silica (B)⁹ | 9 | 0 | 0 | 0 |
| Monomodal precipitated | 0 | 0 | 0 | 23 |
| silica (D)¹¹ | | | | |
| Sulfur curative (sulfur)¹² | 0.9 | 0.9 | 1.2 | 1.2 |
| Sulfur cure accelerator¹³ | 0.9 | 0.9 | 2 | 2 |

TABLE 6-B

| | | Experi- | Experi- | |
|---|---|---|---|---|
| Property | Control 1 | mental B | mental D | Control 4 |
| Storage modulus G′, MPa¹ | 100 | 118 | 110 | 118 |
| Tan delta² | 100 | 82 | 91 | 92 |
| Hot rebound (100° C.) | 100 | 99 | 118 | 102 |
| Toughness³ | 100 | 212 | 140 | 82 |
| Grosch medium abrasion⁴ | 100 | 122 | 87 | 80 |
| Grosch high abrasion⁵ | 100 | 154 | 75 | 77 |
| Tear resistance⁶ | 100 | 145 | 100 | 63 |
| Tear resistance, aged⁷ | 100 | 132 | 99 | 66 |

From Table 6-B it can be seen that hysteresis (rebound and tan delta physical properties) was similar to the Control 1 rubber sample for the rubber sample represented by Experimental rubber Sample B and was significantly and beneficially increased for the rubber sample represented by Experiment D with the included addition of the cis 1,4-polybutadiene and low styrene contend S-SBR for is seen to have enabled a beneficially reduced Grosch high severity rate of abrasion reasonably within the indicated threshold value of Table A and provided a beneficially high toughness yet maintained or improved both the hysteresis and tear resistance properties. It is considered that this is a significant discovery for providing a rubber tread for a pneumatic tire with the result being uncertain without suitable experimentation with the bimodal aggregated sized precipitated silica in a natural rubber-rich tread rubber composition intended for aforesaid mixed service use.

It is thereby concluded that a significant discovery has provided a natural rubber (cis 1,4-polyhisoprene) composition containing the bimodal aggregate sized precipitated silica in the natural rubber (cis 1,4-polyisoprene) as a beneficial improvement in both hysteresis and tear strength as well as toughness for the rubber composition for a tire tread rubber composition intended for the diverse mixed service purpose for the tire tread of this invention, although its abrasion resistance is observed to be somewhat sacrificed.

Such discovery also provides a building into the bimodal aggregate sized precipitated silica containing natural rubber (cis 1,4-polyisooprene) based rubber composition a further improvement for an increased abrasion resistance while being able to maintain the beneficial hysteresis and tear strength properties of the rubber composition by an inclusion of at least one of cis 1,4-butadiene and low styrene, low Tg, S-SBR elastomers with the cis 1,4-polyisoprene rubber for the bimodal aggregate sized precipitated silica containing rubber composition.

It is considered that providing the beneficial combination of hysteresis, tear resistance and abrasion resistance as well as toughness properties for the foresaid tire tread rubber composition for the diverse mixed service application is a discovery resulting from experimentation with the aforesaid combination of bimodal precipitated silica in a natural rubber-rich rubber composition together with at least one of the cis 1,4-polytudiene and low styrene S-SBR elastomers with the result being uncertain until the designed experimentations were conducted. This observation is considered to be particularly applicable for Experimental rubber Sample D of the Example.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art.

1. (canceled)

2. (canceled)

3. (canceled)

4. (canceled)

5. (canceled)

6. (canceled)

7. (canceled)

8. (canceled)

9. (canceled)

10. (canceled)

11. A pneumatic tire having a circumferential rubber tread of a rubber composition comprised of, based on parts by weight per 100 parts by weight of elastomer (phr),
(A) conjugated diene-based elastomers comprised of
(1) about 55 to about 80 phr of cis 1,4-polyisoprene natural rubber, and
(2) about 20 to about 45 phr of additional conjugated diene-based elastomers comprised of a combination of cis 1,4-polybutadiene rubber and organic solution polymerization prepared functionalized styrene/butadiene rubber (S-SBR) having a bound styrene content in a range of from about 12 to about 20 percent;
(B) about 40 to about 120 phr of rubber reinforcing filler comprised of a combination of rubber reinforcing carbon black and aggregates of precipitated silica, wherein said reinforcing filler is comprised of from about 2 to about 50 phr of rubber reinforcing carbon black, and from about 38 to about 118 phr of precipitated silica together with silica coupling agent for said precipitated silica comprised of a bis(3-triethoxysilylpropyl) polysulfide having an average of from about 2 to about 3.8 connecting sulfur atoms in its polysulfidic bridge;
wherein the precipitated silica is comprised of a bimodal aggregate size configured precipitated silica with a monomodal pore size distribution in a range thereof of from about 38 to about 118 phr;
wherein the bimodal aggregate sized precipitated silica is comprised of about 60 to about 80 weight percent of an average aggregate size configuration in a range of from about 0.05 to about 0.11 microns and about 20 to about 40 weight percent of an average size configuration in a range of from about 0.12 to about 1 micron;
wherein said functionalized styrene/butadiene rubber contains functional groups reactive with hydroxyl groups on said bimodal aggregate size configured precipitated silica comprised of siloxy and at least one of amine and thiol groups.

12. (canceled)

13. (canceled)

14. The pneumatic tire of claim 11 wherein said additional conjugated diene based elastomer is comprised of a combination of said cis 1,4-polybutadiene rubber and said functionalized styrene/butadiene rubber having a Tg in a range of about −68° C. to about −72° C.

15. The pneumatic tire of claim 11 wherein the bimodal aggregate size configured precipitated silica aggregates have a nitrogen surface area of greater than 190 m²/g and a pH in a range of from about 3 to about 5.6.

16. The pneumatic tire of claim 14 wherein said precipitated silica also contains from about 2 to about 20 weight percent of monomodal aggregate size configured precipitated silica.

17. The pneumatic tire of claim 11 wherein said functionalized styrene/butadiene rubber is a tin coupled functionalized elastomer.

18. (canceled)

19. The pneumatic tire of claim 17 wherein said tin coupled functionalized styrene/butadiene rubber which contains functional groups reactive with hydroxyl groups contained on said bimodal aggregate sized precipitated silica comprised of siloxy, amine and thiol groups.

20. The pneumatic tire of claim 11 wherein said cis 1,4-polybutadiene rubber is comprised of:
(A) a first cis 1,4-polybutadiene rubber having a microstructure comprised of from about 90 to about 99 percent cis 1,4-isomeric units, a number average molecular weight (Mn) in a range of from about 120,000 to about 300,000 and a heterogeneity index (Mw/Mn) in a range of from about 2.1/1 to about 4.5/1, or
(B) a second cis 1,4-polybutadiene rubber having a microstructure comprised of from about 93 to about 99 percent cis 1,4-isomeric units, a number average molecular weight (Mn) in a range of from about 150,000 to about 300,000 and a heterogeneity index (Mw/Mn) in a range of from about 1.5/1 to about 2/1.

21. The pneumatic tire of claim 20 wherein said cis 1,4-polybutadiene rubber is said first cis 1,4-polybutadiene rubber.

22. The pneumatic tire of claim 20 wherein said cis 1,4-polybutadiene rubber is said second cis 1,4-polybutadiene rubber.
